(19) United States
(12) Patent Application Publication
(10) Pub. No.: US 2022/0321444 A1
(43) Pub. Date: Oct. 6, 2022

(54) Efficient Heartbeat Mechanism for Cloud Applications

(71) Applicant: Siemens Schweiz AG, Zürich (CH)

(72) Inventors: Thomas Gollackner, Oberägeri (CH); Daniel Bögli, Mühlau (CH)

(73) Assignee: Siemens Schweiz AG, Zürich (CH)

(21) Appl. No.: 17/631,189

(22) PCT Filed: Jul. 17, 2020
(86) PCT No.: PCT/EP2020/070318

§ 371 Date: Jan. 28, 2022

(30) Foreign Application Priority Data
Jul. 31, 2019 (DE) 10 2019 211 395.8

(51) Int. Cl. H04L 43/10; H04L 43/0811; H04L 67/10; H04L 67/60

(52) U.S. Cl. CPC H04L 43/10; H04L 43/0811; H04L 67/10; H04L 67/60

(57) ABSTRACT

Various embodiments include a gateway comprising a communication component configured for data communication with a central cloud service. The communication component is configured to send a verification message to the central cloud service to check the operational readiness of a communication connection between the gateway and the central cloud service. The verification message comprises payload information from further components of the gateway.

### CROSS-REFERENCE TO RELATED APPLICATIONS

This application is a U.S. National Stage Application of International Application No. PCT/EP2020/070318 filed Jul. 17, 2020, which designates the United States of America, and claims priority to DE Application No. 10 2019 211 395.8 filed Jul. 31, 2019, the contents of which are hereby incorporated by reference in their entirety.

### TECHNICAL FIELD

The present disclosure relates to cloud computing. Various embodiments include methods for checking the operational readiness of a communication connection between a gateway and a central cloud service and/or gateways configured to carry out the methods.

### BACKGROUND

In information technology (IT) the data exchange between networks, in particular for different types of networks, usually takes place via suitably configured gateways. Gateways are also used to connect networks (for example, networks at corresponding customers) to a cloud infrastructure. In this way, for example, network nodes can access services of cloud applications. In order to verify whether a gateway still has a functioning connection to the cloud, a message is periodically sent via the connection to check the operational readiness of the communication connection (heartbeat function). Message protocols such as MQTT (Message Queuing Telemetry Transport) require a permanently established connection which leads, however, to a continuous data traffic and to a high level of traffic.

### SUMMARY

The teachings of the present disclosure provide an efficient mechanism for checking the operational readiness (heartbeat) between a network gateway and a cloud infrastructure. For example, some embodiments of the teachings herein include a gateway (G) comprising a communication component (B) which is configured for a data communication (KV1) with a central cloud service (A), wherein a verification message (HBN) can be sent from the communication component to the central cloud service (A) to check the operational readiness of the communication connection (KV1) between the gateway (G) and the central cloud service (A), wherein the verification message (HBN) can comprise payload information (NI) from further components (D, D′) of the gateway (G).

In some embodiments, the data communication to the central cloud service (A) is established by means of the communication component (B).

In some embodiments, the payload information (NI1) is an event and/or a value change and/or a status change in the gateway (G).

In some embodiments, the payload information is made available by a corresponding application interface (API) for cloud-based applications.

In some embodiments, the communication component (B) is set up to receive a confirmation (Ack) from the central cloud service (A) as a response to a sent verification message (HBN).

In some embodiments, the communication component (B) is set up to send the verification message (HBN) to the central cloud service (A) periodically at time intervals which can be defined.

In some embodiments, the communication component (B) is set up to send the verification message (HBN) at the request of the central cloud service (A).

As another example, some embodiments include a computer with memory, processor and communication means, configured to realize a gateway (G) as described herein.

As another example, some embodiments include a method for checking the operational readiness of a communication connection (KV1) between a gateway (G) and a central cloud service (A), wherein a verification message (HBN) is sent from a communication component (B) of the gateway (G) to the central cloud service (A) periodically at time intervals which can be defined or on request, wherein the verification message (HBN) can comprise payload information (NI1) from further components (D, D′) of the gateway (G).

In some embodiments, the central cloud service (A), after receipt of the verification message (HBN), sends a confirmation message (Ack) to the gateway (G), wherein the confirmation message (Ack) can comprise payload information (NI2) from further cloud services (C, C′).

In some embodiments, the confirmation message (Ack) is saved in the communication component (B) of the gateway (G) and made available for further components (D, D′) of the gateway (G).

In some embodiments, the time intervals can be defined and modified by the central cloud service (A).

In some embodiments, the verification message (HBN) is sent at the request of the central cloud service (A).

### BRIEF DESCRIPTION OF THE DRAWINGS

The teachings of the present disclosure are further explained using the following figures, in which:

FIG. 1 shows an exemplary gateway, set up to check the operational readiness of the communication connection between the gateway and a central cloud service incorporating teachings of the present disclosure; and

FIG. 2 shows an exemplary flow diagram for a method for checking the operational readiness of a communication connection between a gateway and a central cloud service incorporating teachings of the present disclosure.

### DETAILED DESCRIPTION

The present disclosure teaches various embodiments, including a gateway comprising a communication component which is configured for a data communication with a central cloud service, wherein a verification message (heartbeat) can be sent from the communication component to the central cloud service to check the operational readiness of the communication connection between the gateway and the central cloud service, wherein the verification message can comprise payload information from further components of the gateway. If payload information from further components of the gateway exists or is available, this payload information is transferred together with the verification message. The verification message may have a corresponding data format or a data protocol to transfer the payload information.

In some embodiments, the gateway may be an edge device (edge device computer, edge device, edge gateway). In principle, the gateway can however also be a suitably set up and configured general purpose computer with processor, memory, input/output means, communication means. The example gateway allows an adaptive heartbeat mechanism for cloud applications which is scalable according to communication requirements. By means of the heartbeat mechanism, not only can the operational readiness of a communication connection be determined, but payload data can also be transported by means of the heartbeat mechanism if required. This reduces, among other things, the traffic on the communication connection. The gateway is advantageously a node or a device of a network, for example of a network of devices (e.g. IoT devices) for building automation. The gateway advantageously provides a communication connection (corresponding hardware and software) of the network to the Internet or to a cloud infrastructure (for example, for accessing or activating cloud services).

In some embodiments, the data communication to the central cloud service is established by the communication component of the gateway. The fact that the data connection to the cloud is initialized out of the gateway (or from the gateway) increases the security of the data connection.

The communication connection may be an outgoing connection with bidirectional logic. The communication connection is physically set up from the gateway. The communication connection is physically unidirectional, but logically bidirectional.

Verification messages and the associated payload data can each be buffered, compressed or encrypted in the cloud but also in the gateway.

In some embodiments, the payload information is an event and/or a value change and/or a status change in the gateway. The payload information can therefore be different data types and values.

In some embodiments, the payload information is made available by a corresponding application interface (API) or programming interface for cloud-based applications. Services and applications in the cloud can access payload information by means of the application interface (API) or programming interface and can use said payload information to provide their services and applications.

In some embodiments, the communication component is set up to receive a confirmation from the central cloud service as a response to a sent verification message. The confirmation allows the gateway to recognize that the communication connection is ready for operation. As an option, the confirmation comprises payload information from cloud services or cloud applications for the gateway or for components of the gateway.

In some embodiments, the communication component is set up to send the verification message (heartbeat) to the central cloud service periodically at time intervals which can be defined. The interval for checking the operational readiness of the communication connection can therefore be changed. In some embodiments, the interval for checking the operational readiness of the communication connection can be adapted flexibly to suit existing framework conditions or requirements. The time intervals of the verification message (heartbeat) can be defined or modified by the gateway or by applications on the gateway. The time intervals of the verification message (heartbeat) can however also be defined or modified by cloud services, advantageously depending on existing requirements (for example, with regard to a required reliability of the communication connection).

In some embodiments, the communication component is set up to send the verification message (heartbeat) at the request of the central cloud service. In this way, the verification message (heartbeat) can be sent on demand. This can be useful, for example, in cases of emergency. The implementation may take place by means of container technology. Container technology is to be understood to be a software environment in which the entire code is bundled with all dependencies and can easily be operated on different CPU platforms.

This software environment contains all parts for the operation of an application: operating system, code, runtime, system tools, libraries and settings. This software environment completely isolates the software application from the environment and therefore guarantees high security as regards the isolation of this process. An alternative term for container technology is the term sandbox. One advantage of the container technology is when updating to a newer version: one container can be updated independently and in full without affecting other containers which are in operation on the same CPU during the process. An implementation may take place in a container network, comprising containers both in the device (for example edge device) as well as in the cloud.

In some embodiments, there is a computer with memory, processor and communication means, configured to realize an example gateway. The computer can be a correspondingly set up and configured general purpose computer, for example a desktop computer, laptop, edge device (edge device, edge device computer, for example a set-top box). In principle any commercially available computer can be configured to act as an inventive gateway.

The example gateway in particular establishes a connection of a building automation network to the Internet. A plurality of electronic devices are provided in the building automation network for monitoring and controlling the conditions in a building, in particular for security, fire and flood protection, lighting, heating, ventilation and air conditioning (HVAC).

In some embodiments, the inventive gateway comprises a local network interface which is configured to connect the gateway to the building automation network for communicating with the plurality of electronic devices, a wide area network interface which is configured to connect the gateway to the Internet, a host network unit which is configured to provide a host network on which at least one local service, which corresponds to the monitoring and control of at least one of the conditions in the building, runs, a container network unit which is configured to provide a container network for at least one remote service, in particular a cloud computing service which is provided by a terminal device or a cloud on the Internet for at least one of the electronic devices, a loopback network unit which is configured to provide a loopback network which connects the host network and the container network to each other, and a selection unit which is configured to select a connection mode of the gateway with either at least one of the electronic devices being connected to the Internet via the local network interface or the at least one of the electronic devices being connected to the Internet via the wide area network interface.

In some embodiments, there is a method for checking the operational readiness of a communication connection between a gateway and a central cloud service, wherein a verification message (heartbeat) is sent from a communication component of the gateway to the central cloud service periodically at time intervals which can be defined or on request, wherein the verification message can comprise payload information from further components of the gateway. For the method, no existing communication connection is required between the gateway and the central cloud service or the cloud infrastructure which provides or hosts (implements) the central cloud service. The communication connection can therefore also be realized, for example, by a 3G or 4G network. 5G is not absolutely necessary. The method can be used or is optimized in particular for a mobile data usage so that as little traffic as possible occurs on the communication connection. Conversely, the Message Queuing Telemetry Transport (MQTT) message protocol requires a permanent connection.

In some embodiments, the central cloud service, after receipt of the verification message, sends a confirmation message to the gateway, wherein the confirmation can comprise payload information from further cloud services. Payload information can, for example, be commands, further status queries (system statuses) or configuration data. A simple “slim” heartbeat can comprise further “enriched” payload information. The heartbeat mechanism can therefore be extended or adjusted in a flexible, adaptive and scalable manner to the particular payload information which is to be transferred.

In some embodiments, the confirmation message is saved in the communication component of the gateway and is made available for further components of the gateway or for applications on the gateway. This can take place, for example, via a suitable user interface (API) or programming interface.

In some embodiments, the time intervals being able to be defined and adjusted by the central cloud service. In some embodiments, the interval for checking the operational readiness of the communication connection can be adapted flexibly to suit existing framework conditions or requirements. The time intervals of the verification message (heartbeat) can be defined or modified by the central cloud service, advantageously depending on existing requirements (for example, with regard to a required reliability of the communication connection). The time intervals of the verification message (heartbeat) can however also be defined or modified by the gateway or by applications on the gateway.

In some embodiments, the verification message (heartbeat) being sent at the request of the central cloud service. In this way, the verification message (heartbeat) can be sent on demand. This can be useful, for example, in cases of emergency. The communication connection may be an outgoing connection with bidirectional logic. The communication connection is physically set up from the gateway. The communication connection is physically unidirectional, but logically bidirectional.

Verification messages and the associated payload data can each be buffered, compressed or encrypted in the cloud but also in the gateway.

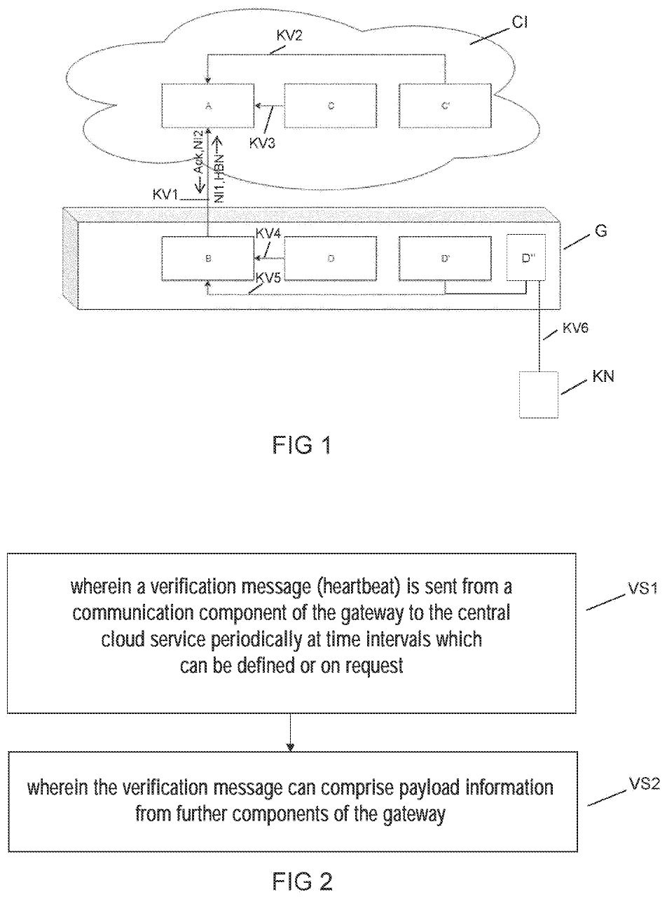

FIG. 1 shows an exemplary gateway G, set up for checking the operational readiness of the communication connection KV1 between the gateway G and a central cloud service A which is hosted or made available in a cloud infrastructure CI. The exemplary gateway G comprises a communication component B which is configured for a data communication with a central cloud service A, wherein a verification message HBN (heartbeat message) can be sent from the communication component B to the central cloud service A to check the operational readiness of the communication connection KV1 between the gateway G and the central cloud service A, and wherein the verification message HBN can optionally comprise payload information NI1 from further components D, D′, D″ of the gateway G.

The communication connection KV1 may include an outgoing connection KV1 from the gateway G with bidirectional logic. The communication connection is physically set up from the gateway G. The communication connection KV1 is physically unidirectional, but logically bidirectional. The communication connection KV1 can be, for example, a correspondingly suitable radio connection, for example based on 3G, 4G or 5G networks. The components B or A used for the communication connection KV1 have corresponding buffers or stacks (for example communication stacks or FIN stacks) for implementing the data traffic on the communication connection KV1 or to save or temporarily save the payload information NI1, NI2.

The verification messages HBN and the associated optional payload data NI1 can each be buffered, compressed or encrypted in the cloud CI but also in the gateway G. The central cloud service A, after receipt of the verification message HBN, may send a confirmation message Ack to the gateway G, wherein the confirmation message Ack can optionally comprise payload information NI2 from further cloud services C, C′. The further cloud services C, C′ can access the central cloud service A by means of suitable communication connections KV2 or KV3.

The payload information NI1, NI2 can, for example, be commands, further status queries (system statuses) or configuration data. A simple “slim” heartbeat can comprise further “cumulative” payload information. The heartbeat mechanism can therefore be extended or adjusted in a flexible, adaptive and scalable manner to the particular payload information NI1, NI2 which is to be transferred.

The confirmation message Ack may be saved in the communication component B of the gateway G and made available for further components D, D′, D″ of the gateway G or for applications on the gateway G. This can take place, for example, via a suitable user interface (API) or programming interface and suitable communication connections KV4 or KV5.

The components or applications B, D, D′, D″ of the gateway G may include containers and be connected via a loopback network.

Implementation as a loopback network prevents, among other things, an external compromising. Using container technology in the gateway G isolates the applications B, D′, D″ which in turn avoids being compromised from an external source (for example in the form of a hacker attack).

In the representation according to FIG. 1, an exemplary communication connection KV6 to an exemplary customer network KN is established via the application D″. The communication connection KV6 may include a TCP/IP connection. The customer network KN is for example a building automation network with a plurality of electronic devices for monitoring and controlling the conditions in a building, in particular for security, fire and flood protection, lighting, heating, ventilation and air conditioning (HVAC).

The time intervals can be defined and modified by the central cloud service A. In some embodiments, the interval for checking the operational readiness of the communication connection KV1 can be adapted flexibly to suit existing framework conditions or requirements. The time intervals of the verification message HBN (heartbeat) can be defined or modified by the central cloud service A, depending on existing requirements (for example, with regard to a required reliability of the communication connection KV1).

The time intervals of the verification message HBN (heartbeat) can however also be defined or modified by the gateway G or by applications D, D′, D″ on the gateway G. The verification message HBN (heartbeat) is optionally sent at the request of the central cloud service A. In this way, the verification message HBN (heartbeat) can be sent on demand. This can be useful, for example, in cases of emergency. The communication component B is advantageously set up to send the verification message HBN (heartbeat) at the request of the central cloud service A. This «heartbeat on demand» makes sense in particular in emergency situations.

The payload information NI1, NI2 can be an event and/or a value change and/or a status change in the gateway G or in the cloud applications or cloud services C, C′. The payload information NI1, NI2 may be provided by a corresponding application interface (API) for cloud-based applications. The communication component B of the gateway G may be set up to receive a confirmation Ack from the central cloud service A as a response to a sent verification message HBN.

The communication component B may be set up to send the verification message HBN (heartbeat) to the central cloud service A periodically at time intervals which can be defined. The gateway G may be an edge device (edge device computer, edge device, edge gateway). In principle, the gateway can however also be a suitably set up and configured general purpose computer with processor, memory, input/output means, communication means. The gateway G can therefore be realized by a correspondingly configured commercially available computer with correspondingly configured software.

FIG. 2 shows an exemplary flow diagram for a method for checking the operational readiness of a communication connection between a gateway and a central cloud service,

(VS1) wherein a verification message (heartbeat) is sent to the central cloud service from a communication component of the gateway periodically at time intervals which can be defined or on request, and

(VS2) wherein the verification message can comprise payload information from further components of the gateway. For the method, no existing communication connection is required between the gateway and the central cloud service or the cloud infrastructure which provides or hosts (implements) the central cloud service.

The communication connection can therefore also be realized, for example, by a 3G or 4G network. A 5G network is not absolutely necessary for carrying out the method. The method can be used or is optimized in particular for a mobile data usage so that as little traffic as possible occurs on the communication connection.

The central cloud service, after receipt of the verification message, advantageously sends a confirmation message to the gateway, wherein the confirmation can comprise payload information from further cloud services. Payload information can, for example, be commands, further status queries (system statuses) or configuration data. A simple “slim” heartbeat can comprise further “cumulative” payload information. The heartbeat mechanism can therefore be extended or adjusted in a flexible, adaptive and scalable manner to the particular payload information which is to be transferred.

The confirmation message is advantageously saved in the communication component of the gateway and made available for further components of the gateway.

The time intervals can advantageously be defined and modified by the central cloud service.

The verification message (heartbeat) is advantageously sent at the request of the central cloud service (i.e. on demand).

The gateway is advantageously an edge device (edge device computer, edge device, edge gateway). In principle, the gateway can however also be a suitably set up and configured general purpose computer with processor, memory, input/output means, communication means. The gateway and the corresponding method can therefore be realized by a correspondingly configured commercially available computer and a correspondingly configured cloud infrastructure with correspondingly configured software.

A gateway, as it is used in this patent application, represents a component, with corresponding hardware and software, for connecting two systems or networks to one another by means of data technology. The gateway can also be a router with corresponding functionality.

Exemplary scenario (use case) inventive method (in conjunction with FIG. 1):
a. A central component on the device (B) periodically sends a message with status information to a central cloud service (A) and expects a confirmation.
b. Further cloud services (C, C′) send their messages, which are to be sent to the device components, to (A) where these are temporarily saved. If outgoing messages are available, this information is added to the confirmation (Ack) from (A) to (B).
c. The device component (B) makes available messages in the Confirm temporary saving via an interface (API, programming interface) for the device components (D, D′). A component (D) or (D′) can therefore collect the messages locally without cyclically having to query a cloud service.
d. If an event/value change/status change is pending in the device (gateway G), this event is packaged in the message from (B) and is sent to (A).
e. The content of this message is now provided as API for further cloud-based applications, different applications can also be notified.
f. (A) does not need to be changed if new cloud services would like to send messages to the device (gateway G).
g. The central components (A) and (B) act only as intermediaries. These components are agnostic as far as the services (C, C′) in the cloud and the components (D, D′) on the device (gateway G) are concerned. Further services and components can therefore be added dynamically (adaptively) without (A) or (B) having to be adapted.

The inventive method as well as the inventive gateway offer, among other things, the following advantages:
Low connection costs and optimized data traffic (in relation to the number of connections and the volume of data to be transmitted) from the gateway to the cloud.
No permanent connection to the cloud is required, resulting in low levels of data traffic (traffic is reduced).
The communication connection to the cloud can also take place in a third or fourth generation mobile network (3G/4G). 5G is not required.
Reduction in data traffic and the costs associated therewith.
Data packet contents are enhanced in an adaptive manner according to requirements.
Data packet contents are made available to the clients on the gateway and on the cloud for further processing—allowing each application to process the information it requires.
Adaptable and scalable heartbeat mechanism for cloud applications.

Method for checking the operational readiness of a communication connection between a gateway and a central cloud service, wherein a verification message (heartbeat) is sent from a communication component of the gateway to the central cloud service periodically at time intervals which can be defined or on request, wherein the verification message can comprise payload information from further components of the gateway. Gateway comprising a communication component which is configured for a data communication with a central cloud service, wherein a verification message (heartbeat) can be sent from the communication component to the central cloud service to check the operational readiness of the communication connection between the gateway and the central cloud service, wherein the verification message can comprise payload information from further components of the gateway.

### REFERENCE CHARACTERS

G Gateway
CI Cloud infrastructure
A, C, C′ Services
B, D, D′, D″ Application
VS1, VS2 Method step
KV1-KV6 Communication connection
HBN Heartbeat message
NI1, NI2 Payload information
Ack Confirmation message
KN Customer network

What is claimed is:

1. A gateway comprising:
a communication component configured for data communication with a central cloud service;
wherein the communication component is configured to send a verification message to the central cloud service to check the operational readiness of a communication connection between the gateway and the central cloud service;
wherein the verification message comprises payload information from further components of the gateway.

2. The gateway as claimed in claim 1, wherein the communication component establishes the data communication to the central cloud service.

3. The gateway as claimed in claim 1, wherein the payload information comprises at least one of: an event, a value change, and/or a status change in the gateway.

4. The gateway as claimed in claim 3, wherein the payload information is made available by a corresponding application interface for cloud-based applications.

5. The gateway as claimed in claim 1, wherein the communication component is configured to receive a confirmation from the central cloud service as a response to a sent verification message.

6. The gateway as claimed in claim 1, wherein the communication component is configured to send the verification message to the central cloud service periodically at defined time intervals.

7. The gateway as claimed in claim 1, wherein the communication component is configured to send the verification message in response to a request from the central cloud service.

8. A computer comprises:
a memory;
a processor; and
a communication component configured for data communication with a central cloud service;
wherein the communication component is configured to send a verification message to the central cloud service to check the operational readiness of a communication connection between the gateway and the central cloud service;
wherein the verification message comprises payload information from further components of the gateway.

9. A method for checking the operational readiness of a communication connection between a gateway and a central cloud service, the method comprising:
sending a verification message from a communication component of the gateway to the central cloud service periodically at time intervals which can be defined or on request;
wherein the verification message comprises payload information from further components of the gateway.

10. The method as claimed in claim 9, further comprising sending, after receipt of the verification message, a confirmation message to the gateway;
wherein the confirmation message comprises payload information from further cloud services.

11. The method as claimed in claim 9, further comprising:
saving the confirmation message in the communication component of the gateway; and
making the confirmation message available for further components of the gateway.

12. The method as claimed in claim 9, wherein the time intervals can be defined and modified by the central cloud service.

13. The method as claimed in claim 9, further comprising sending the verification message at the request of the central cloud service.
